(19) United States
(12) Patent Application Publication
(10) Pub. No.: US 2017/0149521 A1
(43) Pub. Date: May 25, 2017

(54) Sparse Dispersion Compensation Of Optical Data Transmission Paths

(71) Applicants: René-Jean Essiambre, Red Bank, NJ (US); Paul Robert Claisse, Skillman, NJ (US)

(72) Inventors: René-Jean Essiambre, Red Bank, NJ (US); Paul Robert Claisse, Skillman, NJ (US)

(73) Assignee: Alcatel-Lucent USA Inc., Murray Hill, NJ (US)

(21) Appl. No.: 15/355,753

(22) Filed: Nov. 18, 2016

Related U.S. Application Data
(60) Provisional application No. 62/258,139, filed on Nov. 20, 2015.

(51) Int. Cl. H04J 14/02; H04B 10/2525; H04B 10/2513

(52) U.S. Cl. CPC H04J 14/021; H04B 10/25133; H04B 10/25253

(57) ABSTRACT

An apparatus, e.g. an optical data transmission device, is configured to propagate a non-return-to-zero (NRZ) modulated optical communication signal. A plurality of optical amplifiers are configured to receive the modulated optical signal. An optical transmission line includes a sequence of at least five spans of optical fiber, with each adjacent pair of the spans being connected by one of the optical amplifiers. Between about 10% and about 75% of the optical amplifiers include a dispersion compensation module (DCM) and a remainder of the optical amplifiers do not include a DCM, and at least two of said optical amplifiers are optically coupled between a first and a second optical add-drop multiplexer.

### TECHNICAL FIELD

The present invention relates generally to the field of optical communications, and, more particularly, but not exclusively, to methods and apparatus for dispersion compensation in optical data transmission systems.

### BACKGROUND

This section introduces aspects that may be helpful to facilitate a better understanding of the inventions. Accordingly, the statements of this section are to be read in this light and are not to be understood as admissions about what is in the prior art or what is not in the prior art. Any techniques or schemes described herein as existing or possible are presented as background for the present disclosure, but no admission is made thereby that these techniques and schemes were heretofore commercialized, or known to others besides the inventors.

Typical optical data transmission systems use several spans in an optical data transmission path between a transmitter and a receiver. Some optical transmitters use the non-return-to-zero (NRZ) modulation format with dispersion compensation at every span. It is believed that a dispersion compensation module (DCM) is needed at every span to achieve good transmission performance. Moreover, placing a DCM at every span ensure upgradability of optical amplifiers at span origins to optical add-drop multiplexers (OADMs). However, placing a DCM at every span requires a large number of DCMs, which is costly, especially when applied to transmission lines incorporating short spans such as typically done in metropolitan environments.

The low cost of 10 Gb/s transponders and their high capacity granularity makes 10 Gb/s wavelength division multiplexing (WDM) a desirable choice in many newly deployed optical networks, especially in metropolitan and regional networks. An important characteristic of these networks is the heterogeneity of the spans lengths and losses. The maximum reach of 10 Gb/s-based NRZ systems is typically achieved by using dispersion mapping. One commonly used dispersion map is the singly-periodic dispersion (SPD) map that uses a same residual dispersion per span (RDPS) and a DCM for all spans.

### SUMMARY

The inventors disclose various apparatus and methods that may be beneficially applied to, e.g., optical communication systems such as metro and/or regional communications networks. While such embodiments may be expected to provide improvements in performance and/or security of such apparatus and methods, no particular result is a requirement of the present invention unless explicitly recited in a particular claim.

One embodiment provides an apparatus, e.g. an optical transmission path in an optical mesh network, including a plurality of optical amplifiers (OAs) and an optical transmission line. The optical amplifiers are configured to receive a non-return-to-zero (NRZ) modulated optical signal. The optical transmission line includes a sequence of at least five spans of optical fiber. Each adjacent pair of the spans is connected by one of the optical amplifiers. Between about 10% and about 75% of the optical amplifiers include a dispersion compensation module (DCM). A remainder of the optical amplifiers do not include a DCM. At least two of the optical amplifiers are optically coupled between a first and a second optical add-drop multiplexer.

Another embodiment provides an apparatus, e.g. an optical transmission path in an optical mesh network, including a first plurality of optical amplifiers and optical fiber spans configured to receive a non-return-to-zero (NRZ) modulated optical signal. Each of the optical amplifiers is connected to a subsequent optical amplifier by a corresponding one of the fiber spans. Each one of a second plurality of dispersion compensation modules (DCMs) is associated at an amplification node with a corresponding one of the optical amplifiers, with a number of the second plurality being fewer than a number of the first plurality. The first plurality of optical amplifiers includes at least five amplifiers, with at least two of the five optical amplifiers being configured to receive the optical signal from a first OADM and to direct the optical signal toward a second OADM.

Another embodiment provides an apparatus, e.g. an optical transmission path in an optical mesh network. The apparatus includes first and second optical fiber spans of an optical transport line that is configured to transport from a transmitter to a receiver an NRZ-modulated signal having a bit rate of at least about 10 Gb/s. The optical transport line includes a plurality of optical amplifiers, with each of the first and second optical fiber spans being connected to one of the optical amplifiers. A combined length of the first and second spans is at least about 30 km, and a combined length of the optical transport line between the transmitter and receiver is at least about 250 km. Only between about 10% and about 80% of the optical amplifiers are configured to apply optical dispersion compensation to the NRZ-modulated signal.

In various embodiments a number of the DCMs collocated with an OA in the optical transmission path is equal to a summation, over each span of the sequence spans, of an effective cumulative dispersion of each span divided by the cumulative dispersion of a largest DCM in the transmission line, rounded up to a next integer value. In various embodiments the one or more DCMs is configured to provide at least about 1500 ps/nm of dispersion compensation. In various embodiments the optical signal is a chirped NRZ optical signal. In various embodiments the optical signal is a wavelength-division multiplexed (WDM) optical signal. In various embodiments one or more of the DCMs provides dispersion compensation equivalent to at least about 50 km of the optical fiber. In various embodiments the at least five spans have a combined length of at least about 250 km. In various embodiments the optical fiber spans are implemented using non-zero dispersion-shifted fiber (NZDSF). Some embodiments further include an optical data transmitter configured to produce the NRZ modulated optical signal.

Some further embodiments provide methods, e.g. of provisioning an optical transmission system according to any of the preceding apparatuses.

Various embodiments include methods, e.g. of operating an optical mesh network configured as one or more of the apparatus described above.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIGS. 1A and 1B illustrate aspects of optical network terminology used in the description of various embodiments;

FIG. 2 presents a schematic of a segment of an optical communication transmission line, e.g. a heterogeneous segment, that may be configured according to embodiments described herein;

FIG. 3 illustrates three dispersion maps for the nonlimiting example transmission line of FIG. 2) an “ideal” singly-periodic dispersion (SPD) map such may be used in conventional optical communications transmission line; 2) a dispersion map using an adaptive dispersion compensation (ADC) approach as described herein according to various embodiments, and 3) an effective ADC approach, as described herein in relation to various embodiments;

FIG. 4 illustrates three dispersion maps for the same example transmission line as used in FIG. 3: 1) the SPD map as presented in FIG. 3; 2) a dispersion map using sparse dispersion compensation (SDC) configured consistent with embodiments described herein, and 3) a dispersion map based on an effective SDC; and

FIG. 5 illustrates transmission performance based on the ADC and SDC dispersion maps, and the SPD map over 40 spans with 0 dBm and 2 dBm signal launch power, along with a back-to-back at receiver/transmitter performance curve.

### DETAILED DESCRIPTION

Various embodiments are now described with reference to the drawings, wherein like reference numbers are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

Two dispersion map types are described below that may be applicable to various embodiments. A first dispersion map is the ADC map, which prescribes a residual dispersion per span that may in principle be different for each span. Like the SPD map, the ADC map prescribes a DCM for each span of the network. It is shown that the ADC map improves nonlinear transmission relative to conventional heterogeneous-span mesh networks consistent with the SPD map. With respect to transmission lines, “heterogeneous” means that the lengths and/or losses of the spans are unequal. A second dispersion map described below is the SDC map. In this prescription, fewer than all of the spans of the optical mesh network include a DCM. It is shown that networks employing features of various embodiments that use the SDC map may significantly reduce the number of DCMs relative to systems consistent with the SPD map and the ADC map.

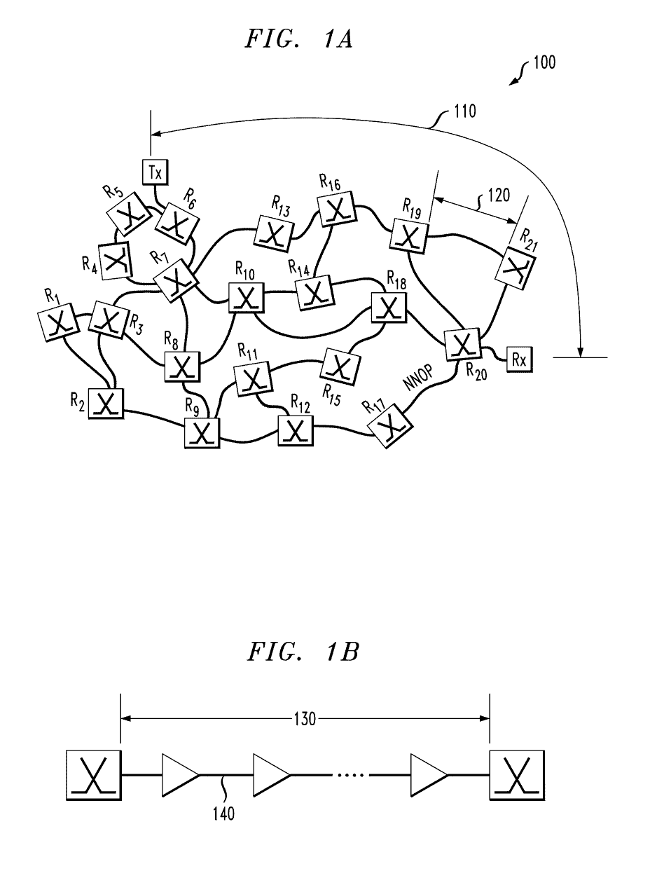

FIGS. 1A and 1B illustrate aspects of optical network terminology used in the description of various embodiments, and in the claims. FIG. 1A illustrates an optical mesh network 100 that includes a transmitter Tx and a receiver Rx. Between the Tx and Rx are located N add-drop multiplexers (OADMs) R_{N}. The Tx and Rx are connected by several paths 110 that can be traced through the network 100 via any number of the OADMs. Any such path may be referred to as a “transmission line”, “optical transport line” or simply “line”. In the illustrated example, all such lines include at least one OADM, but in principle a transmission line may connect the Tx and Rx with no intervening OADM.

A “line segment” connects two OADMs. A representative line segment 120 connects R₁₉ and R₂₁. Each OADM is connected to at least two line segments, but may be connected to more than two. For example, six line segments connect R₇ to respective neighboring OADMs.

Each line segment includes one or more “spans”. FIG. 1B illustrates a single line segment 130 connecting two unreferenced OADMs. The line segment 130 includes M spans 140, each span being coupled to a neighboring span via an amplifier at an amplification node. In principle, two OADMs may be connected directly by a span without an intervening amplifier, e.g. when the optical distance between the OADMs is sufficiently small.

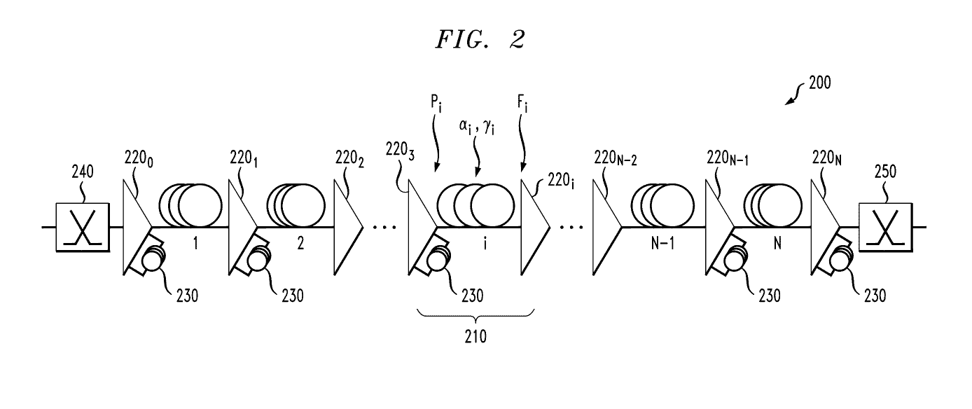

FIG. 2 presents a schematic of an apparatus, e.g. an optical communication transmission line segment 200 that includes a plurality N of spans 210. Each span 210 originates at an output of a preceding optical amplifier (OA) 220, and ends at an input to a following OA 220. Thus, for N spans 210 the illustrated embodiment includes N+1 OAs 220, designated for convenience as 220₀, 220₁, 220₂, . . . 220_{N}. Some, but not all, of the OAs 220 are associated with a DCM 230 also between two spans 210. The line segment 200 is preceded by an input OADM 240 located to add an optical channel to a signal propagating along the line segment 200, and an output OADM 250 located to drop an optical channel from the propagating signal. The first OA 220₀ in the line segment 200, i.e. immediately following the OADM 240, is typically a component of and located within the OADM 240, while the last OA 220_{N} in the line segment 200, i.e. immediately preceding the OADM 250, is typically a component of and located within the OADM 250. While the OA 220₀ is shown including a DCM 230, the DCM 230 may or may not be present at this site depending on, e.g., the dispersion compensation prescription of the previous line segment. Similarly, the OA 220_{N} is shown including a DCM 230, but the DCM 230 may or may not be present at this site depending on, e.g., the results of the SDC mapping procedure described below. For the purposes of the description and the claims, the OA 220₀ is not considered to be a portion of the line segment 200.

In various embodiments the line segment 200 is configured to receive an optical signal that is non-return-to-zero (NRZ) modulated. In some such embodiments the NRZ signal is chirped. In some embodiments the optical fiber used to implement the spans 210 has a dispersion between about 16.5 ps/nm-km and about 17.5 ps/nm-km at 1550 nm wavelength. The spans 210 may be implemented using non-zero dispersion-shifted fiber (NZDSF) such as enhanced large effective area fiber (ELEAF), available from, e.g. Corning Inc., Corning N.Y., USA, or TrueWave® fiber, available from, e.g. OFS Fitel, LLC, Norcross Ga., USA. The benefit provided by various embodiments may be more apparent for line segments 200 having at least about 250 km length, with at least two spans 210 per line segment 200 and at least five spans per transmission line. In such systems, it may not be possible to place one or more OAs 220 without placement of a corresponding DCM 230 without incurring an unacceptable transmission error rate (BER) for an NRZ signal if one or more features of a described embodiment are not also included.

Table 1 below displays characteristics of a nonlimiting example transmission line using the general architecture of the line segment 200 for the case of five spans, e.g. N=5 in FIG. 2, for a total of 250 km. This example is used without limitation to demonstrate various principles of the embodiments. Further reference to the line segment 200 is made assuming the example configuration of FIG. 2, noting though that according to some embodiments described below one or more of the DCMs 230 may be advantageously omitted as previously described and further illustrated.

TABLE 1

| Span | Length | Loss | Power | ADC RDPS |
|---|---|---|---|---|
| # | (km) | (dB) | (dBm) | (ps/nm) |
| 1 | 65 | 13 | 1.5 | 36.5 |
| 2 | 50 | 10 | 0 | 24.5 |
| 3 | 40 | 8 | −1 | 18.2 |
| 4 | 35 | 7 | −1.5 | 15.4 |
| 5 | 60 | 12 | 1 | 32.1 |

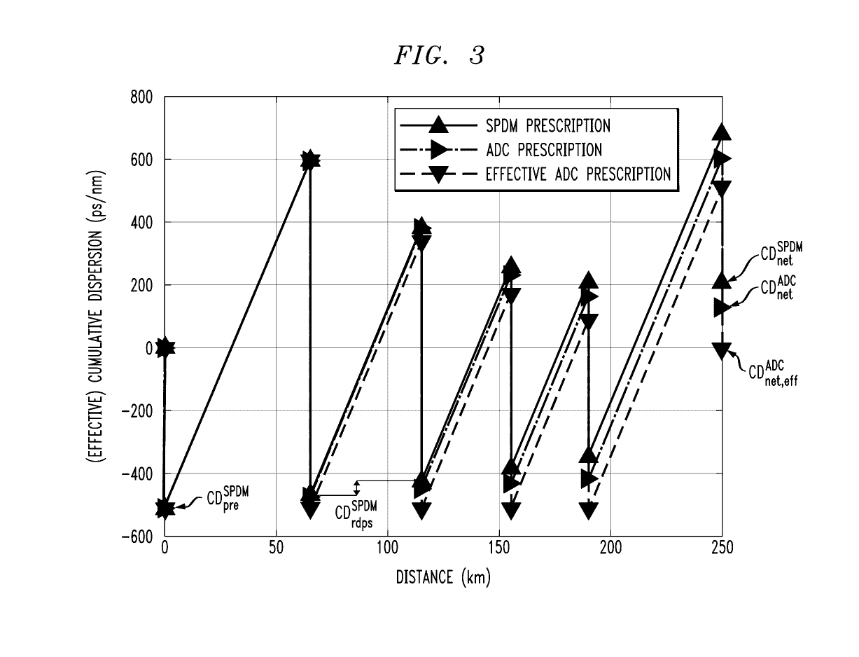

FIG. 3 presents three cumulative dispersion characteristics of the line segment 200 for reference in the following discussion. An “SPD prescription” represents an “ideal” SPD map; an “ADC prescription” refers to an adaptive dispersion compensation scheme as described below; and an “Effective ADC prescription” refers to an ADC scheme using an effective dispersion compensation as described further below. The SPD prescription is determined according to conventional principles. An SPD map may be defined by three parameters: 1) dispersion pre-compensation, CDₚᵣₑ^{SPDM}; 2) RDPS, CD_{rdps}^{SPDM}; and 3) net residual dispersion, CDₙₑₜ^{SPDM}. Based on a nonlimiting example of homogeneous-span lines with 80-km-long spans, a loss coefficient of 0.2 dB/km and identical signal input powers to all spans, the numerically and experimentally tested parameters of the optimum SPD map for long-distance transmission (2000 km) over standard single-mode fiber (SSMF) at 10 Gb/s and 50-GHz spacing for the NRZ format have been determined to be CDₚᵣₑ^{SPDM}=−510 ps/nm, CD_{rdps}^{SPDM}=42 ps/nm and CDₙₑₜ^{SPDM}=CD_{rdps}^{SPDM}*N.

For sufficiently long fiber spans, the optimum input power per span in heterogeneous transmission lines can be approximated by

$${P}_{i}^{dB} - {P}_{avg}^{dB} ≃ \frac{1}{2} ( {Γ}_{i} - {Γ}_{avg} ) ,$$

where the averages are performed on quantities “in dBs”, i.e. P_{avg}^{dB}≡Σᵢ^{N} Pᵢ^{dB}/N and Γᵢ/N. Of course, embodiments are not limited to such optimum configurations. The quantity Pᵢ^{dB} is the signal power per WDM channel at the transmission fiber input expressed in dBs. The span loss Γᵢ is given by Γᵢ=−10 log₁₀ Tᵢ=10αᵢLᵢ log₁₀ e, where the transmittivity Tᵢ≡exp(−αᵢLᵢ), 0<Tᵢ<1, with αᵢ and Lᵢ being the span loss coefficient and length, respectively (see FIG. 2).

The ADC scheme may be useful in some embodiments, e.g. to improve nonlinear transmission in heterogeneous-span networks. In the ADC scheme, an effective RDPS value of span i, CD_{rdps,eff}⁽ⁱ⁾ is defined as

$${CD}_{rdps , eff}^{i} = \frac{{φ}_{NL}^{( i )}}{{φ}_{NL}^{SPDM}} {CD}_{rdps}^{SPDM} \qquad ( 1 )$$

where CD_{rdps}^{SPDM} is a reference RDPS for the SPD map, and φ_{NL}^{SPDM} is the nonlinear phase of the reference span, both in a homogeneous-span line; and φ_{NL}⁽ⁱ⁾ is the nonlinear phase of the i^{th} span. It is believed that the quantity CD_{rdps,eff}⁽ⁱ⁾ can be loosely interpreted as the effective compensation of dispersion caused by transmission nonlinearity over each span i. The nonlinear phase follows the commonly used definition, φ_{NL}(z)=∫₀^{z} γ(z)P(z)dz, where P(z) is the evolution of the power per WDM channel with distance z, and γ(z) is the nonlinear coefficient that depends on distance. For 10 Gb/s NRZ on a 50-GHz grid over SSMF, the reference nonlinear phase φ_{NL}^{SPDM}=42.6 milliradians. The effective cumulative dispersion CD_{eff}ⁱ of span i is defined as CD_{eff}⁽ⁱ⁾=CD⁽ⁱ⁾−CD_{rdps,eff}⁽ⁱ⁾, where CD⁽ⁱ⁾ is the cumulative dispersion of the fiber span i, and CD_{rdps,eff}⁽ⁱ⁾ is the ADC prescription of the RDPS given in Eq. (1).

Referring back to the example of Table 1 and FIG. 3, the span input powers per channel are calculated based on P_{avg}^{dB}=0 dBm. The net residual dispersion CDₙₑₜ^{ADC} is 120 ps/nm, or about 57% of the 210 ps/nm CDₙₑₜ^{SPDM} of the SPD map. The effective ADC map that removes the nonlinear contribution to each span is shown in FIG. 3 as “effective ADC prescription”. It corresponds to all spans having an effective RDPS of zero or, equivalently, all spans having identical effective pre-compensation CDₚᵣₑ=−510 ps/nm.

It is noted that while the description above refers to a bit rate of 10 Gb/s, the embodiments described herein may be beneficially applied to NRZ-modulated signals having a bit rate greater than 10 Gb/s.

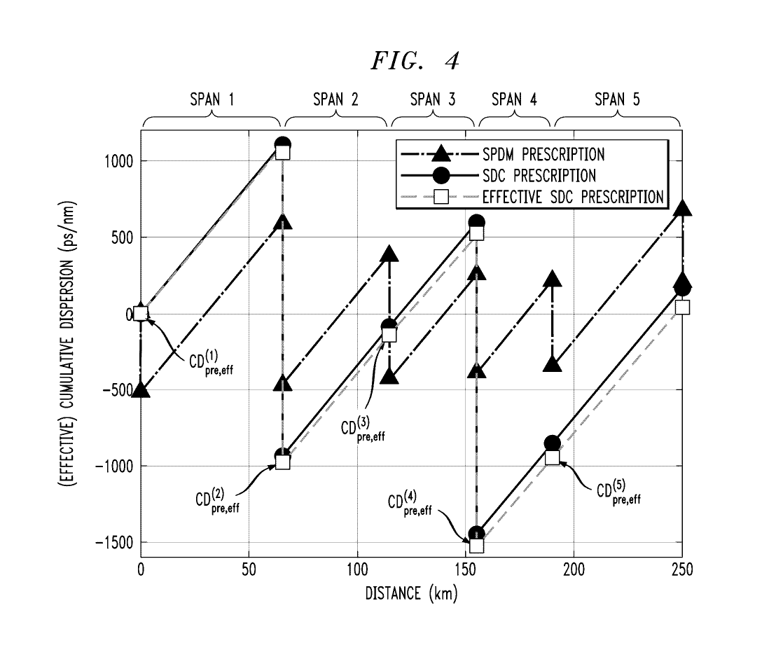

The SDC methodology is now described. Reducing the number of DCMs 230 and the frequency of dispersion compensation may be beneficial to reduce system cost and potentially increase system performance. A minimum number of DCMs 230 using SDC may be determined by summing the effective cumulative dispersion CD_{eff}⁽ⁱ⁾ of all spans and dividing by the cumulative dispersion of the largest DCM and rounding up. In the illustrated embodiment the size of the DCMs is selected to be as equal as possible within “DCM10” granularity (e.g. steps of 10-km of SSMF dispersion compensation fiber). A “best” SDC map is obtained by the minimization of the average of the weighted sum of the difference of effective cumulative dispersion [symbol] :

$$𝒜 = min \vert {\sum }_{i = 1}^{N} ( {CD}_{pre , eff}^{( i )} - {CD}_{pre}^{SPDM} ) \frac{{φ}_{NL}^{( i )}}{{φ}_{NL}^{SPDM}} \vert \qquad ( 2 )$$

where CD_{pre,eff}⁽ⁱ⁾ is the effective cumulative dispersion at the input of span i (see effective SDC prescription in FIG. 4), while other parameters are as previously defined. The values of CD_{pre,eff}⁽ⁱ⁾ are given by CD_{pre,eff}⁽ⁱ⁾=CD_{DCM}⁽⁰⁾+Σⱼ₌₁ⁱ⁻¹ (CD_{eff}^{(j)}+CD_{DCM}^{(j)}), where CD_{DCM}⁽ⁱ⁾ is a vector of length N+1, representing the DCM dispersion compensation values that establish the SDC map; and CD_{DCM}⁽⁰⁾=CDₚᵣₑ^{SPDM}. The prescription of the SDC map given by Eq. (2) is based on the minimization of the differences in the effective pre-compensation of the SDC and ADC prescriptions. The DCMs calculated for the SPD map and the ADC maps have the same layout, e.g. {DCM30, DCM60, DCM50, DCM40, DCM30, DCM30} from the first to the sixth OA 220, respectively, of the example embodiment of FIG. 2. This specific result can occur when the line segment is short, but need not be true in all cases. However, the input signal power to the spans for the SPD map is fixed to 0 dBm/ch, while for the ADC map each span has its own input power as given in Table 1.

FIG. 4 illustrates cumulative dispersion as a function of transmission distance for the SDC and effective SDC maps based on the effective ADC prescription of FIG. 3, both built with DCMs having DCM10 granularity and with a maximum size DCM of DCM 230. The SPD map illustrated in FIG. 3 is repeated for reference. The following discussion continues to reference to FIG. 2, with N=6 spans for example and without limitation. Referring first to the SPD map, a DCM 230 is present at all the nodes between spans. A transmitter (not shown) collocated with the OADM 240 applies about a −500 ps/nm precompensation at the beginning (zero km) of the line segment 200. The cumulative dispersion initially increases along Span 1 to about 600 ps/nm. At a first node between Spans 1 and 2, the DCM 230 at that node applies about −1000 ps/nm of dispersion compensation to reduce the cumulative dispersion to about −470 ps/nm. The cumulative dispersion increases along Span 2 to about 400 ps/nm and is then corrected by another DCM 230 to about −450 ps/nm. The cumulative dispersion increases along Span 3 to about 300 ps/nm and is then corrected by another DCM 230 to about −400 ps/nm. The cumulative dispersion increases along Span 4 to about 250 ps/nm and is then corrected by another DCM 230 to about −350 ps/nm. The cumulative dispersion increases along Span 5 to about 700 ps/nm and is then corrected by a final DCM 230 to about 100 ps/nm. Notably, the largest dispersion compensation applied in the line segment 200 by a DCM 230 instance in this example is about −1000 ps/nm.

Referring next to the SDC and effective SDC prescription maps of FIG. 4, the line segment 200 is configured according to embodiments described herein, e.g. to have a DCM 230 at fewer than all of the nodes between the fiber spans. These maps were computed using DCMs with DCM10 granularity. Referring to the relationship described earlier between the sum of the effective dispersions CD_{eff}⁽ⁱ⁾ of the spans and the largest DCM used, using a maximum DCM size of DCM 230 (e.g. equivalent of about 140 km of dispersion compensation), the 250 km, 5-span line segment requires two DCMs 230. Solving Eq. (2) places the DCMs at the second and fourth OAs 220 of the six OAs 220.

Referring to the SDC map of FIG. 4, initially, the transmitter does not apply any precompensation dispersion value to the transmitted signal. The cumulative dispersion increases to about 1000 ps/nm over Span 1, and then is corrected to about −2000 ps/nm by a DCM 230 at the end of the span that applies about −2000 ps/nm dispersion compensation. The cumulative dispersion then increases to about 500 ps/nm over the next two spans, Span 2 and Span 3. No dispersion compensation is applied at the amplification node between these spans. At the end of Span 3, a DCM 230 applies a compensation value of about −2000 ps/nm to result in a cumulative dispersion of about −1500 ps/nm at the beginning of Span 4. Notably, The DC applied after Span 1 and after Span 3 significantly exceeds the maximum DC that is applied in conventional systems, such as exemplified by the SPD map, e.g. compensation no greater than about 1000 ps/nm in that example. The cumulative dispersion increases along Span 4 and Span 5 to about 100 ps/nm at the end of Span 5, e.g. at a receiver (not shown) collocated with the OADM 250. Again, no dispersion compensation is applied between these spans. Thus, the SDC prescription results in two fewer instances of the DCM 230 in the line segment 200 than needed in the SPD prescription.

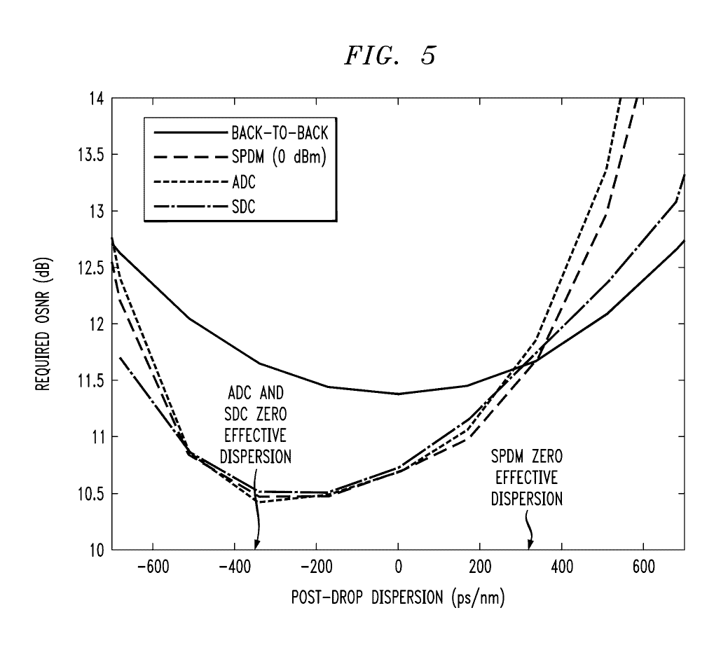

FIG. 5 shows computed required optical signal-to-noise ratio (OSNR, in dB and assuming 10⁻³ bit-error rate, BER) vs. post-drop dispersion simulated for five cases: the “ideal” SPD map with 0 dBm signal launch power, the ADC dispersion map and the SDC dispersion map. The required OSNR was computed assuming transmission over 40 spans obtained by repeating the 5-span line segments described by Table 1 eight times for each of the three dispersion maps. The back-to-back required OSNR curve is included as a reference. The SPD map, ADC and SDC maps all have a total nonlinear phase of one radian to within a few percent. These three maps show similar required OSNR curves, with very close agreement between about −500 ps/nm and about +400 ps/nm, indicating that using the SDC methodology does not significantly reduce performance Indeed, the zero-effective dispersion for the SPD map is offset by about 700 ps/nm from the optimum value of post-drop compensation while both ADC and SDC maps targets fall nearly exactly at the optimum. In addition, the SDC map has slightly more margin of error in dispersion than the other maps. Without limitation by theory, this is thought to indicate that a reduction of the number of locations of dispersion compensation in SDC reduces the occurrence of realignment in time of the WDM channels, thereby reducing cross-phase modulation. The SPD map results suggest that the optimum dispersion values at the drop location follow the ADC and SDC prescriptions while the SPD prescription may be off by many hundreds of ps/nm.

Note that, as previously described, a DCM 230 may be omitted form a span in some conventional optical mesh networks when the length of that span is less than about 30 km. Embodiments described herein are in marked contrast to such conventional omission in that a DCM 230 may be omitted when one span, or two or more spans without any intervening dispersion compensation, exceeds a length of 30 km, e.g. 35 km, 50 km or greater. For example, referring to Table I and the SDC map of FIG. 4 without limitation, for example, the combination of Span 2 and Span 3 runs 90 km without DC, and the combination of Span 4 and 5 runs 90 km without compensation. The ability to reduce the number of DCMs 230 without performance penalty provides a significant cost-reducing option for metro transmission system design, e.g. up to about 400 km. It is specifically noted, however, that embodiments may confer a similar advantage to some regional, e/g/up to about 800 km, and long-haul, e.g. up to about 2000 km or more, optical transmission networks. It is believed that significant benefit is provided for transmission lines that include at least five spans, at least two of which are located between OADMs, e.g. the example describe above that includes five spans between OADMs. While the number of omitted spans will depend on the specifics of a particular system design, it is expected that beneficial balance of cost and performance will result when between about 25% and about 75% of the OAs 220 include a DCM 230 and the remainder of the OAs 220 do not include a DCM 230. In some networks, such performance and/or economic benefit may result when between 20% and 60% the OAs 220 include a DCM 230, and in some cases the range may be extended to as few as about 10% and as many as about 80% depending on network configuration. Of course a single mesh network, e.g. such as the network 100 in FIG. 1, may include many line segments 120, each of which may in principle be constrained differently than the others of the segments 120. Using the methodology described above, different segments 120 in the same network may be optimized differently, such that the segments have a different fraction of omitted DCMs.

Note that while the exact dispersion compensation applied by a DCM 230 at the end of multiple uncompensated spans 210 may be determined by the specific configuration of a subject line segment 120, the degree of dispersion compensation provided by such a dispersion compensator is well above that provided by dispersion compensators in known conventional implementations. As exemplified by the SPD map illustrated in FIGS. 3 and 4, the maximum conventional dispersion compensation may be up to about 1100 ps/nm over a single span. Even allowing for the possibility of possible excursions above 1100 ps/nm dispersion compensation over a single span in conventional implementations, it seems unlikely that such excursions would reach about 1400 ps/nm dispersion compensation over a single span. In marked contrast to conventional practice, embodiments according to the disclosure may have one or more DCMs 230 configured to provide 1500 ps/nm dispersion compensation or greater, depending on the particular implementation of the line segment 200. Indeed, as shown above in one example embodiment, the dispersion compensation may be about 2000 ps/nm or greater. Note also that such values of dispersion compensation, significantly larger than those provided in known conventional implementations, go far beyond dispersion compensation values in the scope of design choice. Indeed, dispersion compensation values of at least about 1500 ps/nm, and in some cases about 2000 ps/nm and greater, are enabled by the principles underlying the described embodiments, e.g. arranging the span lengths and dispersion compensation values consistent with Eq. 2. Finally, while some ring networks are known in which a DCM may be omitted from an amplification node, known examples of such implementations rely on equal path lengths between ring nodes. In marked contrast, the embodiments described herein provide optimization that may be applied to the more arbitrary path lengths of a mesh network. In particular, it is noted that optimization based on such known ring-network examples would not result in satisfactory results if applied to mesh networks, at least because of the inherent path length differences in the mesh network context.

Herein and in the claims, the term “provide” with respect to an optical transmission system encompasses designing or fabricating the system, causing the system to be designed or fabricated, and/or obtaining the system by purchase, lease, rental or other contractual arrangement.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, application specific integrated circuit (ASIC), field programmable gate array (FPGA), read only memory (ROM) for storing software, random access memory (RAM), and nonvolatile storage. Other hardware, conventional and/or custom, may also be included. Similarly, any Fes shown in the figures are conceptual only. Their function may be carried out through the operation of program logic, through dedicated logic, through the interaction of program control and dedicated logic, in conjunction with the appropriate computer hardware, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An apparatus, comprising:
a plurality of optical amplifiers configured to receive a non-return-to-zero (NRZ) modulated optical signal; and
an optical transmission line having a sequence of at least five spans of optical fiber, each adjacent pair of the spans being connected by one of the optical amplifiers,
wherein between about 10% and about 75% of the optical amplifiers include a dispersion compensation module (DCM) and a remainder of the optical amplifiers do not include a DCM, and wherein at least two of said optical amplifiers are optically coupled between a first and a second optical add-drop multiplexer.

2. The apparatus of claim 1, wherein a number of said DCMs is equal to a summation, over each span of said sequence, of an effective cumulative dispersion of said each span divided by the cumulative dispersion of a largest DCM in said transmission line, rounded up to a next integer value.

3. The apparatus of claim 1, wherein said DCM is configured to provide at least about 1500 ps/nm of dispersion compensation.

4. The apparatus of claim 1, wherein said optical amplifiers are further configured to receive a chirped NRZ optical signal.

5. The apparatus of claim 1, wherein said DCM provides dispersion compensation equivalent to at least about 50 km of said optical fiber.

6. The apparatus of claim 1, wherein said at least five spans have a combined length of at least about 250 km.

7. The apparatus of claim 1, wherein said optical fiber spans are implemented using non-zero dispersion-shifted fiber (NZDSF).

8. The apparatus of claim 1, wherein said optical amplifiers are further configured to receive a wavelength-division multiplexed (WDM) optical signal.

9. The apparatus of claim 1, further comprising an optical data transmitter configured to produce said NRZ modulated optical signal.

10. A method, comprising:
forming optical transmission line having a sequence of at least five spans of optical fiber, each adjacent pair of spans being connected by one of the optical amplifiers; and
wherein between about 10% and about 75% of the optical amplifiers include a dispersion compensation module (DCM) and a remainder of the optical amplifiers do not include a DCM, and wherein at least two of said optical amplifiers are optically coupled between a first and a second optical add-drop multiplexer.

11. The method of claim 10, wherein a number of said DCMs is equal to a summation, over each span of said sequence, of an effective cumulative dispersion of said each span divided by the cumulative dispersion of a largest DCM in said transmission line, rounded up to a next integer value.

12. The method of claim 10, wherein said DCM is configured to provide at least about 1500 ps/nm of dispersion compensation.

13. The method of claim 10, wherein said optical amplifiers are configured to receive a chirped NRZ optical signal.

14. The method of claim 10, wherein said DCM provides dispersion compensation equivalent to at least about 50 km of said optical fiber.

15. The method of claim 10, wherein said at least five spans have a combined length of at least about 250 km.

16. The method of claim 10, wherein said optical fiber spans are implemented using non-zero dispersion-shifted fiber (NZDSF).

17. The method of claim 10, wherein said optical amplifiers are further configured to receive a wavelength-division multiplexed (WDM) optical signal.

18. The method of claim 10, further comprising optically coupling said optical transmission line to an optical data transmitter configured to produce said NRZ modulated optical signal.

19. The method of claim 10, wherein between about 20% and about 60% of the optical amplifiers include a DCM and the remainder of the optical amplifiers do not include a DCM.

20. An apparatus, comprising:
a first plurality of optical amplifiers and optical fiber spans configured to receive a non-return-to-zero (NRZ) modulated optical signal, each of said optical amplifiers being connected to a subsequent optical amplifier by a corresponding one of said plurality of fiber spans;
a second plurality of dispersion compensation modules (DCMs) each being associated at an amplification node with a corresponding one of the optical amplifiers, a number of said second plurality being fewer than a number of said first plurality; and
first and second optical add-drop multiplexers,
wherein said first plurality includes at least five optical amplifiers, at least two of said five optical amplifiers are configured to receive said optical signal from said first OADM and to direct said optical signal toward said second OADM.

21. A method, comprising:
configuring a first plurality of optical amplifiers and optical fiber spans to receive a non-return-to-zero (NRZ) modulated optical signal, each of said optical amplifiers being connected to a subsequent optical amplifier by a corresponding one of said plurality of fiber spans;
coupling each of a second plurality of dispersion compensation modules (DCMs) to a corresponding one of the optical amplifiers, a number of said second plurality being fewer than a number of said first plurality,
wherein said first plurality includes at least five optical amplifiers, at least two of said five optical amplifiers being configured to receive said optical signal from a first optical add-drop multiplexer and to direct said optical signal toward a second OADM.

22. An apparatus, comprising:
first and second optical fiber spans of an optical transport line configured to transport from a transmitter to a receiver an NRZ-modulated signal having a bit rate of at least about 10 Gb/s, the optical transport line including a plurality of optical amplifiers, and each of the first and second optical fiber spans being connected to one of the optical amplifiers,
wherein a total length of said first and second spans is at least about 30 km and a total length of said optical transport line between the transmitter and receiver is at least about 250 km, with only between about 10% and about 80% of the optical amplifiers being configured to apply optical dispersion compensation to said NRZ-modulated signal.

23. A method, comprising:
configuring first and second optical fiber spans of an optical transport line to transport from a transmitter to a receiver an NRZ-modulated signal having a bit rate of at least about 10 Gb/s, the optical transport line including a plurality of optical amplifiers, and each of the first and second optical fiber spans being connected to one of the optical amplifiers,
wherein a total length of said first and second spans is at least about 30 km and a total length of said optical transport line between the transmitter and receiver is at least about 250 km, with only between about 10% and about 80% of the optical amplifiers being configured to apply optical dispersion compensation to said NRZ-modulated signal.
